(19) United States
(12) Patent Application Publication
(10) Pub. No.: US 2024/0172850 A1
(43) Pub. Date: May 30, 2024

(54) PROTECTIVE COVER ASSEMBLY

(71) Applicant: Primax Electronics Ltd., Taipei (TW)

(72) Inventors: Shao-Wei Yang, Taipei (TW); Yi-Hsien Lin, Taipei (TW)

(21) Appl. No.: 18/094,162

(22) Filed: Jan. 6, 2023

(30) Foreign Application Priority Data
Nov. 30, 2022 (TW) 111145935

(51) Int. Cl. A45C 11/00; F16C 11/04; G06F 1/16

(52) U.S. Cl. CPC A45C 11/00; F16C 11/04; G06F 1/1628; A45C 2011/003

(57) ABSTRACT

A protective cover assembly is provided, which includes a bracket and a biaxial structure. The bracket has a first portion and a second portion pivotally connected to each other. The biaxial structure has a first rotating shaft and a second rotating shaft, in which a portion of the first portion of the bracket away from the second portion is configured to be pivotally connected to or separated from the first rotating shaft or magnetically connected to or separated from the first rotating shaft, and the second rotating shaft is configured to be pivotally connected to a component.

### FIELD OF THE INVENTION

The present invention relates to a protective cover assembly, in particular to a protective cover assembly for a tablet computer.

### BACKGROUND OF THE INVENTION

Use modes of a commercially available protective cover assembly are limited. For example, a commercially available product can provide a floating screen mode, but cannot provide a drawing mode (folded in reverse); another commercially available product can provide a drawing mode (folded in reverse), but cannot provide a floating screen mode. Therefore, there is an urgent need in the field for a protective cover assembly that can provide various modes to meet various needs of users.

### SUMMARY OF THE INVENTION

The present disclosure provides a protective cover assembly, which includes a bracket and a biaxial structure. The bracket has a first portion and a second portion pivotally connected to each other. The biaxial structure has a first rotating shaft and a second rotating shaft, in which a portion of the first portion of the bracket away from the second portion is configured to be pivotally connected to or separated from the first rotating shaft or magnetically connected to or separated from the first rotating shaft, and the second rotating shaft is configured to be pivotally connected to a component.

In some embodiments of the present disclosure, the bracket is configured to support a tablet computer.

In some embodiments of the present disclosure, the second portion is configured to magnetically attract the tablet computer.

In some embodiments of the present disclosure, the protective cover assembly further includes the component, the second rotating shaft being pivotally connected to the component, in which the component is a keyboard device, a touch panel or a tablet computer.

In some embodiments of the present disclosure, the portion of the first portion of the bracket away from the second portion is configured to be pivotally connected to or separated from the first rotating shaft, and the portion of the first portion away from the second portion has at least one hook portion, and the first rotating shaft has at least one groove configured to accommodate a portion of the at least one hook portion, and the biaxial structure further includes a casing covering the first rotating shaft, and the casing has at least one through opening, and the portion of the at least one hook portion is able to enter the at least one groove through the at least one through opening, or to leave the at least one groove and the at least one through opening, so that the portion of the first portion away from the second portion is able to be pivotally connected to or separated from the first rotating shaft.

In some embodiments of the present disclosure, the at least one hook portion is L-shaped.

In some embodiments of the present disclosure, the at least one through opening includes an axial portion and a circumferential portion connected to the axial portion, and the at least one groove is able to be substantially aligned with the axial portion and a portion of the circumferential portion, and when the portion of the at least one hook portion passes through the at least one through opening and enters the at least one groove, the portion and another portion of the at least one hook portion are able to be rotated respectively in the groove and the circumferential portion to rotate the first rotating shaft, so that the groove deviates from the axial portion and the portion of the circumferential portion.

In some embodiments of the present disclosure, the portion of the first portion of the bracket away from the second portion is configured to be magnetically connected to or separated from the first rotating shaft, and a magnet is provided in the portion of the first portion away from the second portion, and another magnet is provided in the first rotating shaft correspondingly.

In some embodiments of the present disclosure, the magnet and the other magnet are a pair of Halbach array magnets.

In some embodiments of the present disclosure, the portion of the first portion away from the second portion has a concave portion, and the first rotating shaft has a convex portion corresponding to the concave portion.

In some embodiments of the present disclosure, the biaxial structure further includes a casing covering opposite ends of the first rotating shaft and exposing a middle portion of the first rotating shaft.

### BRIEF DESCRIPTION OF THE DRAWINGS

Aspects of the present disclosure are best understood from the following embodiments, read in conjunction with the accompanying drawings. It should be understood, however, that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a schematic perspective view of a protective cover assembly according to an embodiment of the present invention.

FIG. 2 is a partially enlarged view of FIG. 1.

FIG. 3 is a schematic perspective view of the protective cover assembly of FIG. 2 after assembly.

FIG. 4 is a schematic perspective view of a protective cover assembly according to an embodiment of the present invention.

FIG. 5 is a partially enlarged view of FIG. 4.

FIG. 6 is a schematic perspective view of the protective cover assembly of FIG. 5 after assembly.

FIG. 7 is a schematic perspective view of a protective cover assembly showing a floating screen mode according to an embodiment of the present invention.

FIG. 8 is a schematic perspective view of a protective cover assembly showing a closed mode according to an embodiment of the present invention.

FIG. 9 is a schematic perspective view of a protective cover assembly showing a flattened mode according to an embodiment of the present invention.

FIG. 10 is a schematic perspective view of a protective cover assembly showing a drawing mode (folded in reverse) according to an embodiment of the present invention.

FIG. 11 is a schematic perspective view of a protective cover assembly showing a separation mode according to an embodiment of the present invention.

### DETAIL DESCRIPTION OF THE PREFERRED EMBODIMENT

The advantages and features of the present disclosure and the method for achieving the same will be described in more detail with reference to exemplary embodiments and the accompanying drawings to make it easier to understand. However, the present disclosure can be implemented in different forms and should not be construed as being limited to the embodiments set forth herein. On the contrary, for those skilled in the art, the provided embodiments will make this disclosure more thorough, comprehensive and complete to convey the scope of the present disclosure.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180 degrees, the relationship between the one element and the other element may change from “beneath” to “over.” In addition, the spatially relative descriptions used herein should be interpreted the same.

As described in the related art, the use modes of the commercially available protective cover assembly are limited. Accordingly, the present invention provides a novel protective cover assembly to solve the above issues.

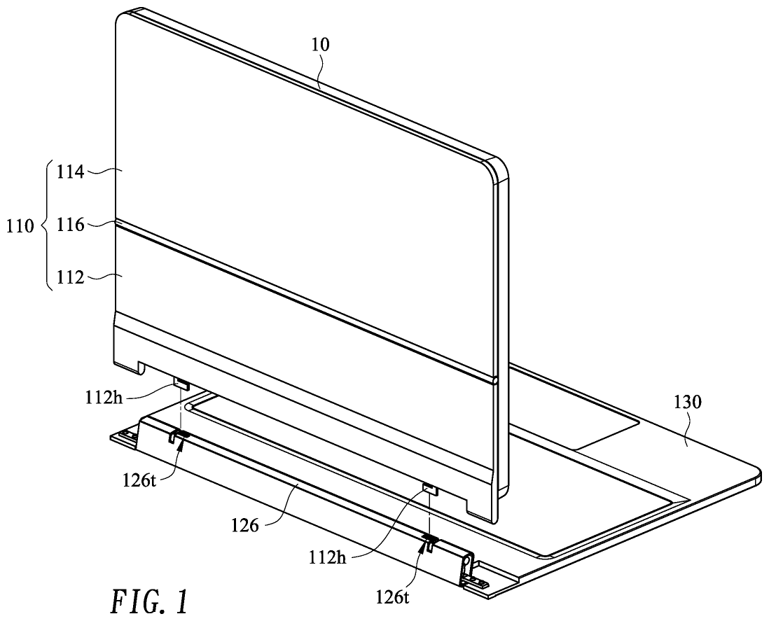

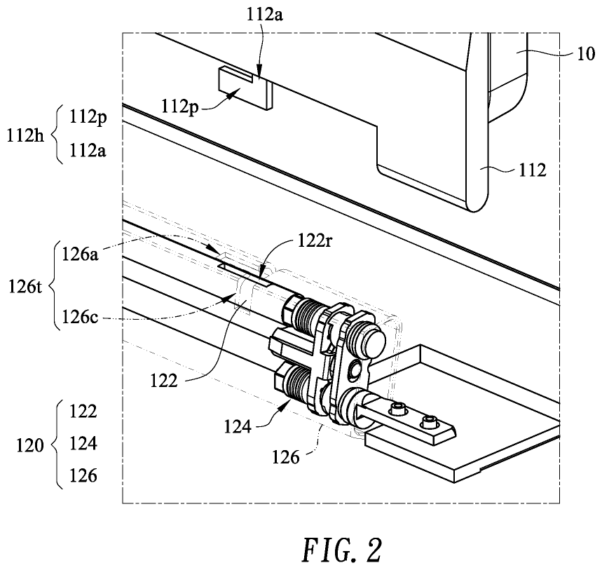

Various embodiments of the protective cover assembly of the present invention are described in detail below. FIG. 1 is a schematic perspective view of a protective cover assembly according to an embodiment of the present invention. FIG. 2 is a partially enlarged view of FIG. 1. As shown in FIGS. 1 and 2, the protective cover assembly includes a bracket 110 and a biaxial structure 120. The bracket 110 has a first portion 112 and a second portion 114 pivotally connected to each other. In some embodiments, the bracket 110 further has a rotating shaft 116, and the first portion 112 and the second portion 114 are pivotally connected to each other through the rotating shaft 116.

In some embodiments, the bracket 110 is configured to support a tablet computer 10. In some embodiments, the second portion 114 is configured to magnetically attract the tablet computer 10 to fix the tablet computer 10 on the second portion 114. In some embodiments, a magnet (not shown) is disposed inside the second portion 114, which can attract the tablet computer 10 with a corresponding magnet (not shown) inside.

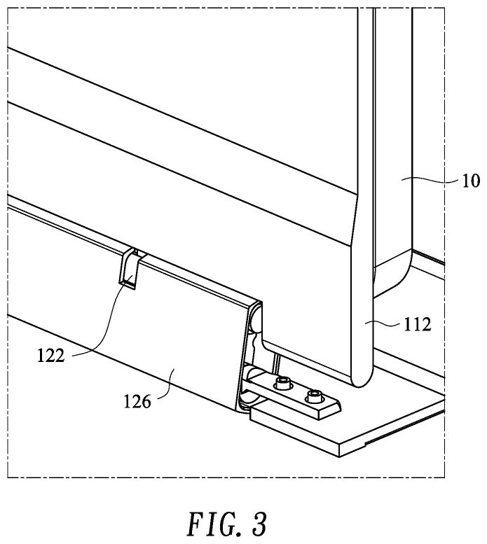

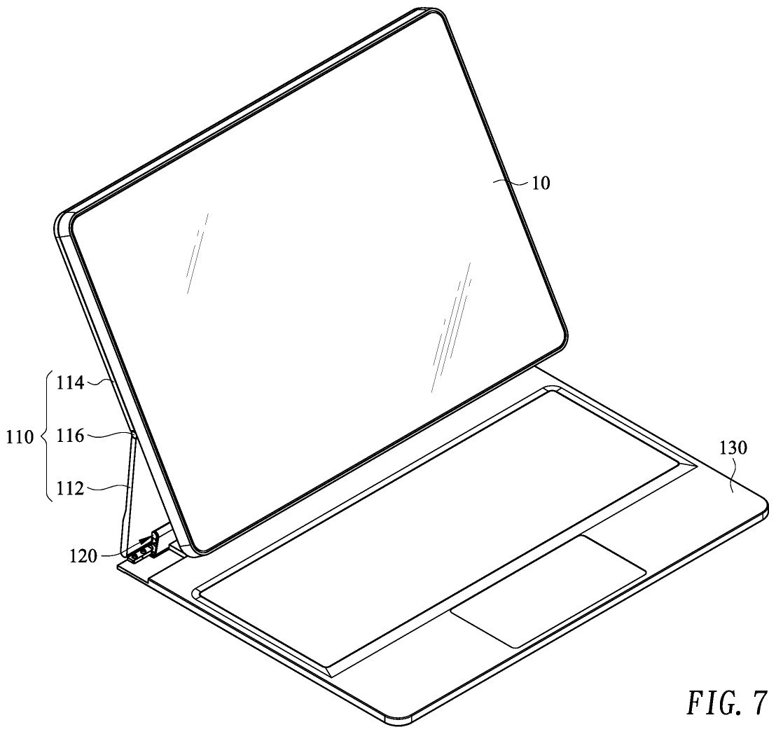

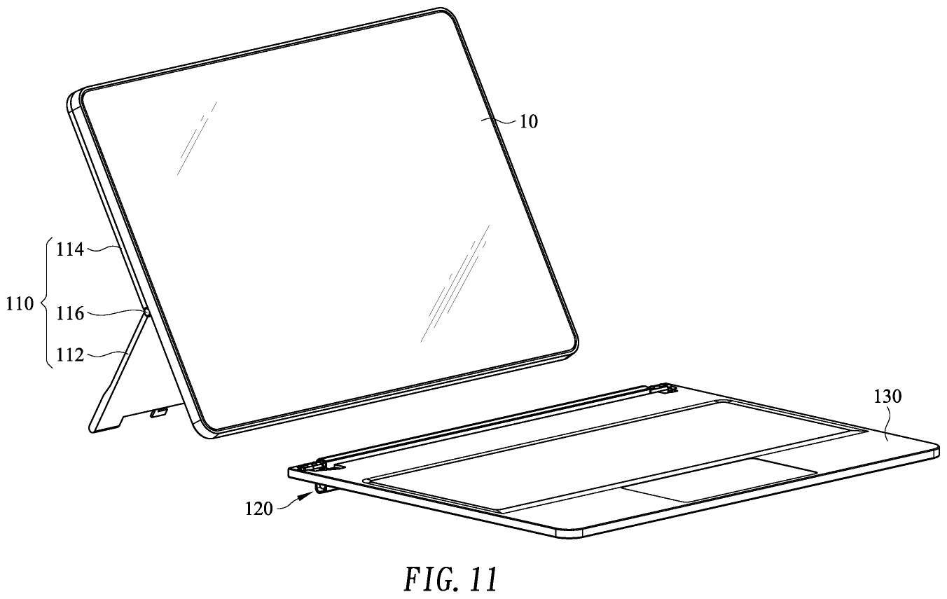

FIG. 3 is a schematic perspective view of the protective cover assembly of FIG. 2 after assembly. As shown in FIGS. 1, 2 and 3, the biaxial structure 120 has a first rotating shaft 122 and a second rotating shaft 124, and a portion of the first portion 112 of the bracket 110 away from the second portion 114 is configured to be pivotally connected to the first rotating shaft 122 (as shown in FIG. 3) or separated from the first rotating shaft 122 (as shown in FIG. 2), and the second rotating shaft 124 is configured to be pivotally connected to a component 130 (as shown in FIG. 1). As such, the protective cover assembly of the present invention can provide various use modes after the protective cover assembly is assembled (e.g., a floating screen mode, a closed mode, a flattened mode, and a drawing mode shown in FIGS. 7 to 10) and a use mode after the protective cover assembly is separated (e.g., a separation mode shown in FIG. 11), and thus can meet various usage requirements of users. In some embodiments, the protective cover assembly further includes the component 130, and the second rotating shaft 124 is pivotally connected to the component 130, in which the component 130 is a keyboard device (as shown in FIG. 1), a touchpad or a tablet computer. However, the present invention is not limited thereto, and the component 130 may be other suitable input/output devices.

In some embodiments, as shown in FIGS. 1, 2 and 3, the portion of the first portion 112 of the bracket 110 away from the second portion 114 is configured to be pivotally connected to or separated from the first rotating shaft 122. The portion of the first portion 112 away from the second portion 114 has at least one hook portion 112h, and the first rotating shaft 122 has at least one groove 122r configured to accommodate a portion 112p of the at least one hook portion 112h, and the biaxial structure 120 further includes a casing 126 covering the first rotating shaft 122, and the casing 126 has at least one through opening 126t. In some embodiments, the at least one hook portion 122h is L-shaped. In some embodiments, the casing 126 further covers (or surrounds) the second rotating shaft 124.

It should be noted that the portion 112p of the at least one hook portion 112h is able to pass through the at least one through opening 126t and then enter the at least one groove 122r, so that the portion of the first portion 112 away from the second portion 114 is able to be pivotally connected to the first rotating shaft 122; the portion 112p of the at least one hook portion 112h is able to leave the at least one groove 122r and the at least one through opening 126t, so that the portion of the first portion 112 away from the second portion 114 is separated from the first rotating shaft 122.

In some embodiments, as shown in FIG. 2, the at least one through opening 126t includes an axial portion 126a and a circumferential portion 126c connected to the axial portion 126a, and the at least one groove 122r is able to be substantially aligned with the axial portion 126a and a portion of the circumferential portion 126c (e.g., a portion connected to the axial portion 126a). When the portion 112p of the at least one hook portion 112h passes through the at least one through opening 126t (i.e., the axial portion 126a and the portion of the circumferential portion 126c) and then enters the at least one groove 122r, the portion 112p and another portion 112a of the at least one hook portion 112h is able to be rotated respectively in the groove 122r and the circumferential portion 126c to rotate the first rotating shaft 122, so that the groove 122r of the first rotating shaft 122 deviates from the axial portion 126a and the portion of the circumferential portion 126c of the through opening 126t. As such, the first portion 112 of the bracket 110 will not be separated from the first rotating shaft 122. That is to say, when in use, the user can hold the bracket 110 and put the portion 112p of the hook portion 112h of the first portion 112 into the groove 122r of the first rotating shaft 122, and then rotate the first portion 112 (the hook portion 112h is rotated together to rotate the first rotating shaft 122), and thus the groove 122r deviates from the axial portion 126a and the portion of the circumferential portion 126c of the through opening 126t, so that the first portion 112 will not be separated from the first rotating shaft 122.

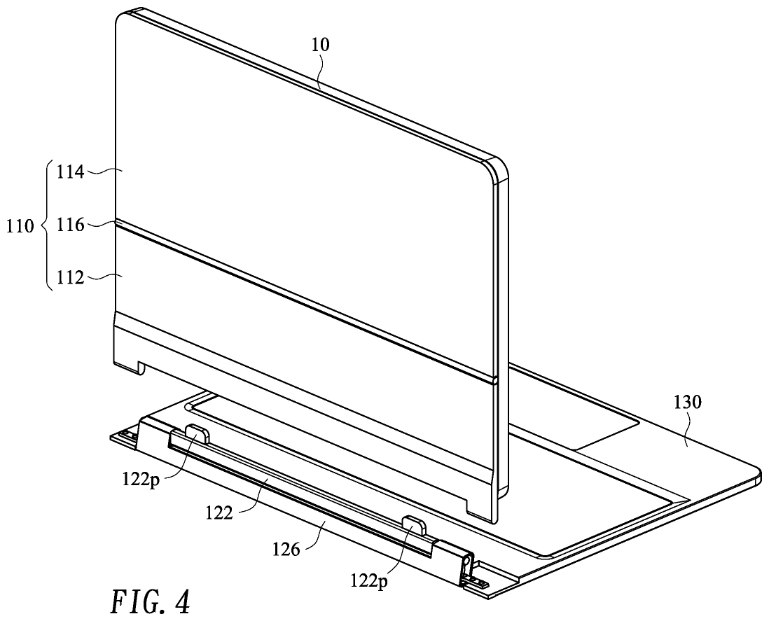

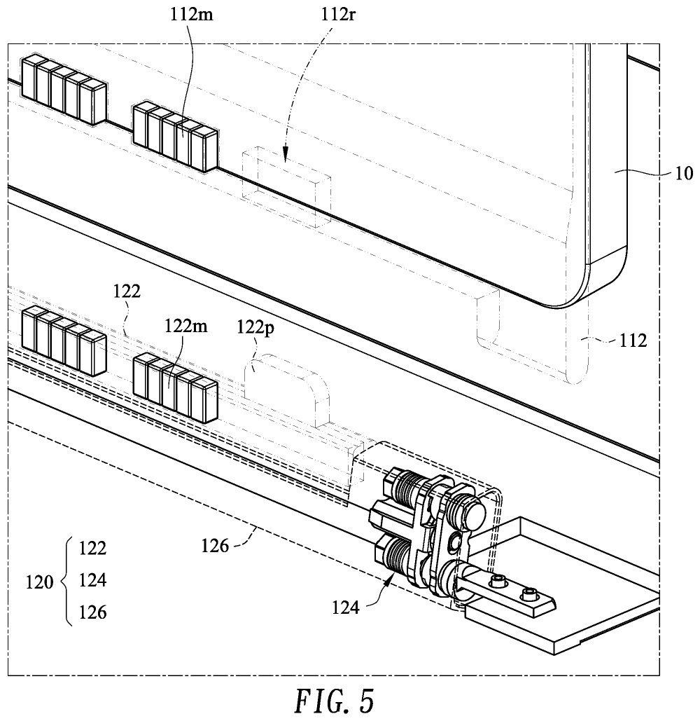

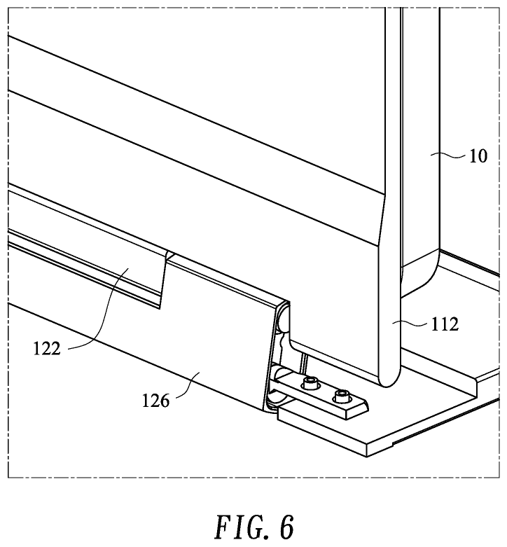

FIG. 4 is a schematic perspective view of a protective cover assembly according to an embodiment of the present invention. FIG. 5 is a partially enlarged view of FIG. 4. FIG. 6 is a schematic perspective view of the protective cover assembly of FIG. 5 after assembly. The difference between the embodiments of FIGS. 4, 5 and 6 and the embodiments of FIGS. 1, 2 and 3 is that, as shown in FIGS. 4, 5 and 6, a portion of a first portion 112 away from a second portion 114 is configured to be magnetically connected to a first rotating shaft 122 (as shown in FIG. 6) or separated from the first rotating shaft 122 (as shown in FIG. 5), and a magnet 112m is provided in the portion of the first portion 112 away from the second portion 114, and another magnet 122m is provided in the first rotating shaft 122 correspondingly. In some embodiments, the magnet 112m and the other magnet 122m are a pair of Halbach array magnets.

In some embodiments, the portion of the first portion 112 away from the second portion 114 has a concave portion 112r (or a convex portion, not shown), and the first rotating shaft 122 has a convex portion 122p (or a concave portion, not shown) corresponding to the concave portion 112r (or the convex portion). The user can hold the bracket 110 and fit the convex portion 122p into the concave portion 112r, at this time, the magnet 112m and the magnet 122m are magnetically attracted to each other. Similar to the embodiments of FIGS. 1, 2 and 3, in the embodiments of FIGS. 4, 5 and 6, after the concave portion 112r is fitted with the convex portion 122p, the user can rotate the first portion 112 (the first rotating shaft 122 is rotated accordingly), due to the magnetic attraction force between the magnet 112m and the other magnet 122m and the fit between the concave portion 112r and the convex portion 122p, the first portion 112 is not easily separated from the first rotating shaft 122.

In some embodiments, the biaxial structure 120 further includes a casing 126 covering opposite ends of the first rotating shaft 122 and exposing a middle portion of the first rotating shaft 122. In some embodiments, the casing 126 further covers (or surrounds) the second rotating shaft 124.

FIG. 7 is a schematic perspective view of a protective cover assembly showing a floating screen mode according to an embodiment of the present invention. Please refer to FIGS. 2, 3 and 7, after the user puts the hook portion 112h of the first portion 112 into the groove 122r of the first rotating shaft 122, the user can rotate only the second portion 114, or rotate the first portion 112 and the second portion 114, so that the protective cover assembly presents the floating screen mode. In some embodiments, the first rotating shaft 122 of the biaxial structure 120 and the rotating shaft 116 of the bracket 110 are equipped with torsion structures, so an inclination angle of the first portion 112 and that of the second portion 114 may be adjusted steplessly, so that the tablet computer 10 can present various inclination angles to meet the needs of users.

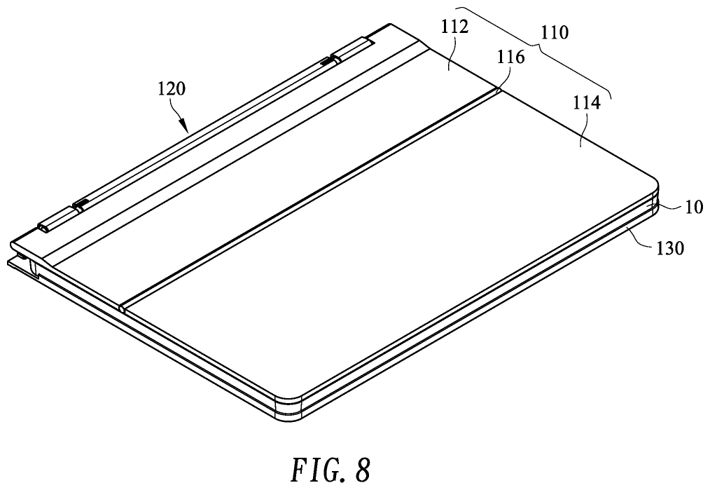

FIG. 8 is a schematic perspective view of a protective cover assembly showing a closed mode according to an embodiment of the present invention. Please refer to FIGS. 2, 3 and 8, after the user puts the hook portion 112h of the first portion 112 into the groove 122r of the first rotating shaft 122, the user can rotate the bracket 110, so that the protective cover assembly presents the closed mode.

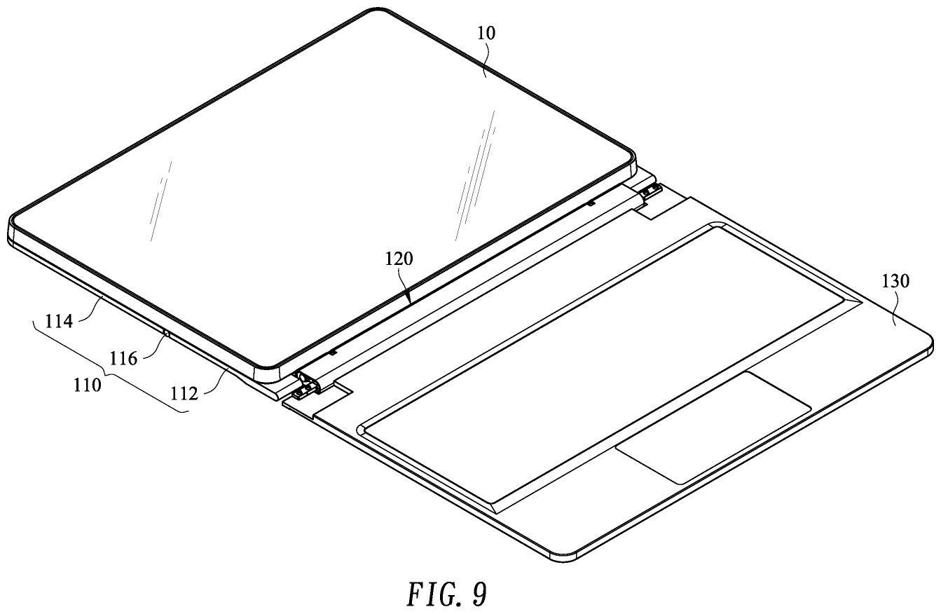

FIG. 9 is a schematic perspective view of a protective cover assembly showing a flattened mode according to an embodiment of the present invention. Please refer to FIGS. 2, 3 and 9, after the user puts the hook portion 112h of the first portion 112 into the groove 122r of the first rotating shaft 122, the user can rotate the casing 126 of the biaxial structure 120 and the bracket 110, so that the protective cover assembly presents the flattened mode.

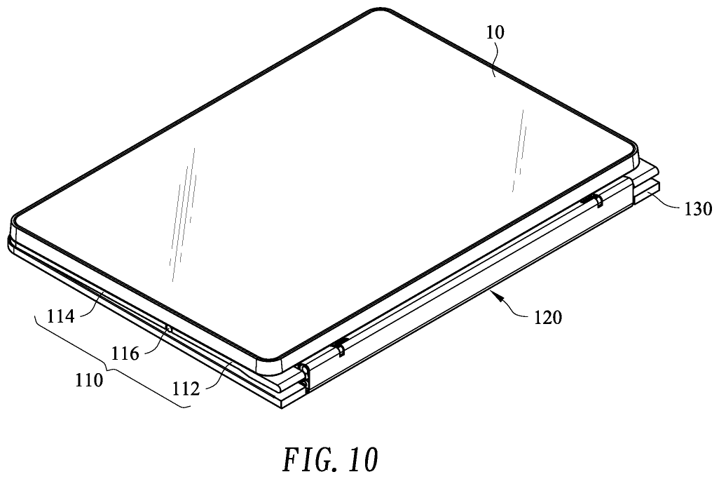

FIG. 10 is a schematic perspective view of a protective cover assembly showing a drawing mode (folded in reverse) according to an embodiment of the present invention. Please refer to 2, 3 and 10, after the user puts the hook portion 112h of the first portion 112 into the groove 122r of the first rotating shaft 122, the bracket 110 and the component 130 can be rotated, so that the protective cover assembly presents the drawing mode.

FIG. 11 is a schematic perspective view of a protective cover assembly showing a separation mode according to an embodiment of the present invention. Please refer to FIGS. 2 and 11, the user can rotate the first portion 112, so that the bracket 110 and the tablet computer 10 can stand on a table; in addition, the user can rotate the casing 126 of the biaxial structure 120, so that one end of the casing 126 containing the first rotating shaft 122 is in contact with a surface of the table, and the component 130 can present an appropriate inclination angle, which can enrich the user's experience when using the component 130.

The protective cover assembly of the embodiments shown in FIGS. 4 to 6 can also implement the floating screen mode, the closed mode, the flattened mode, the drawing mode and the separation mode as shown in FIGS. 7 to 11, which will not be repeated below.

However, the above are only the preferred embodiments of the present disclosure, and should not be used to limit the scope of implementation of the present disclosure, that is, simple equivalent changes and modifications made in accordance with claims and description of the present disclosure are still within the scope of the present disclosure. In addition, any embodiment of the present disclosure or claim does not need to achieve all the objectives or advantages disclosed in the present disclosure. In addition, the abstract and the title are not used to limit the scope of claims of the present disclosure.

What is claimed is:

1. A protective cover assembly, comprising:
a bracket having a first portion and a second portion pivotally connected to each other; and
a biaxial structure, having a first rotating shaft and a second rotating shaft, wherein a portion of the first portion of the bracket away from the second portion is configured to be pivotally connected to or separated from the first rotating shaft or magnetically connected to or separated from the first rotating shaft, and the second rotating shaft is configured to be pivotally connected to a component.

2. The protective cover assembly of claim 1, wherein the bracket is configured to support a tablet computer.

3. The protective cover assembly of claim 2, wherein the second portion is configured to magnetically attract the tablet computer.

4. The protective cover assembly of claim 1, further comprising:
the component, the second rotating shaft being pivotally connected to the component, wherein the component is a keyboard device, a touch panel or a tablet computer.

5. The protective cover assembly of claim 1, wherein the portion of the first portion of the bracket away from the second portion is configured to be pivotally connected to or separated from the first rotating shaft, and the portion of the first portion away from the second portion has at least one hook portion, and the first rotating shaft has at least one groove configured to accommodate a portion of the at least one hook portion, and the biaxial structure further comprises a casing covering the first rotating shaft, and the casing has at least one through opening, and the portion of the at least one hook portion is able to enter the at least one groove through the at least one through opening, or to leave the at least one groove and the at least one through opening, so that the portion of the first portion away from the second portion is able to be pivotally connected to or separated from the first rotating shaft.

6. The protective cover assembly of claim 5, wherein the at least one hook portion is L-shaped.

7. The protective cover assembly of claim 5, wherein the at least one through opening comprises an axial portion and a circumferential portion connected to the axial portion, and the at least one groove is able to be substantially aligned with the axial portion and a portion of the circumferential portion, and when the portion of the at least one hook portion passes through the at least one through opening and enters the at least one groove, the portion and another portion of the at least one hook portion are able to be rotated respectively in the groove and the circumferential portion to rotate the first rotating shaft, so that the groove deviates from the axial portion and the portion of the circumferential portion.

8. The protective cover assembly of claim 1, wherein the portion of the first portion of the bracket away from the second portion is configured to be magnetically connected to or separated from the first rotating shaft, and a magnet is provided in the portion of the first portion away from the second portion, and another magnet is provided in the first rotating shaft correspondingly.

9. The protective cover assembly of claim 8, wherein the magnet and the other magnet are a pair of Halbach array magnets.

10. The protective cover assembly of claim 8, wherein the portion of the first portion away from the second portion has a concave portion, and the first rotating shaft has a convex portion corresponding to the concave portion.

11. The protective cover assembly of claim 8, wherein the biaxial structure further comprises a casing covering opposite ends of the first rotating shaft and exposing a middle portion of the first rotating shaft.
